(19) United States
(12) Patent Application Publication
(10) Pub. No.: US 2003/0186722 A1
(43) Pub. Date: Oct. 2, 2003

(54) Method and device for real time GSM user device profile interrogation and registration

(75) Inventor: Moshe Weiner, Yahud (IL)

Correspondence Address: SUGHRUE MION, PLLC, 2100 PENNSYLVANIA AVENUE, N.W., WASHINGTON, DC, 20037, US

(73) Assignee: COMVERSE, LTD.

(21) Appl. No.: 10/107,306

(22) Filed: Mar. 28, 2002

(51) Int. Cl. H04M 1/00

(52) U.S. Cl. 455/558; 455/557; 455/466

(57) ABSTRACT

A mobile communication system and method in which device-specific profile data relating to a target mobile device is solicited by the mobile communication network prior to relaying a regular mobile message from a sending mobile device to the target mobile device. The target mobile device responds to the solicitation by providing data such as display size, memory capacity and software capabilities. The mobile communication network formats the regular message in accordance with the target device's response and, accordingly, the regular message is displayed on the target mobile device in a manner efficiently tailored to the capabilities of the target device.

### FIELD OF THE INVENTION

The present invention relates generally to the field of digital cellular communications. More particularly, the invention is directed to the area of transferring multi-format data between GSM devices and the flexibility required by the communication system to accommodate such transfers.

### BACKGROUND OF THE INVENTION

There are two basic types of services offered through GSM (Global System for Mobile Communication): telephony (also referred to as teleservices) and data (also referred to as bearer services). Telephony services are mainly voice services that provide subscribers with the complete capability (including necessary terminal equipment) to communicate with other subscribers. Data services provide the capacity necessary to transmit appropriate data signals between two access points creating an interface to the network. In addition to normal telephony and emergency calling, GSM supports dual-tone multifrequency (DTMF), facsimile group III, cell broadcast, voice mail, fax mail and Short Message Services (SMS).

The SMS service makes use of an SMSC (Short Message Service Center), which acts as a store-and-forward system for short messages. The wireless network provides the mechanisms required to find the destination station(s) and transport short messages between the SMSC and wireless stations. In contrast to other existing text-message transmission services, such as alphanumeric paging, the service elements in SMS are designed to provide guaranteed delivery of text messages to the destination. Additionally, SMS supports several input mechanisms that allow interconnection with different message sources and destinations.

SMS is characterized by out-of-band packet delivery and low-bandwidth message transfer, which results in a highly efficient means for transmitting short bursts of data. Initial applications of SMS focused on eliminating alphanumeric pagers by permitting two-way general-purpose messaging and notification services, primarily for voice mail. As technology and networks evolved, a variety of services have been introduced, including e-mail, fax, paging integration, interactive banking, information services such as stock quotes, and integration with Internet-based applications. Wireless data applications include downloading of SIM (Subscriber Identity Module) cards for activation, debit, profile-editing purposes, wireless points-of-sale (POSs), and other field-service applications such as automatic meter reading, remote sensing, and location-based services. Additionally, integration with the Internet spurred the development of Web-based messaging and other interactive applications such as instant messaging, gaming, and chatting.

One of the most popular ways an SMS message is sent and/or received is via a GSM handset equipped with SMS capabilities. An identification number is first stored in the memory of the handset. This identification number identifies the Mobil Switching Center (MSC) to which each SMS message from that particular handset will be sent for proper distribution to the intended recipient. The identification number only needs to be stored once and each time an SMS message is generated using that handset, the stored number is used for message routing.

After storing the proper MSC identification number, SMS messages are typically created using the GSM handset by manually entering a combination of message text and/or characters by pressing the appropriate keys located either on the handset itself or on an accessory keyboard that can be operably attached to the handset or Personal Digital Assistant (PDA).

Unified Messaging (UM) is an innovative new technology that unites disparate voice, fax and e-mail messaging systems into a single unified mailbox and enables access from a PC or from any touch-tone telephone. Streamlined access to and management of information afforded by UM dramatically enhances the productivity and responsiveness of office workers, telecommuters, mobile employees as well as IT staff throughout an organization. For example, the people within an enterprise are better equipped to make fast, effective business decisions, in the office or on the road.

Wireless Application Protocol (WAP) is an application environment and set of communication protocols for wireless devices. WAP is designed to enable manufacturer-independent, vendor-independent, and technology-independent access to the Internet and advanced telephony services. WAP overlays standard data link protocols, such as GSM, CDMA (Code Division Multiple Access), and TDMA (Time Division Multiple Access), and provides a complete set of network communication programs comparable to and supportive of the Internet set of protocols. The WAP Forum is an industry association of over 200 members that has developed the de-facto world standard for wireless information and telephony services on digital mobile phones and other wireless terminals.

WAP bridges the gap between the mobile world and the Internet as well as corporate intranets and offers the ability to deliver an unlimited range of mobile value-added services to subscribers—independent of their network, bearer, and terminal. Mobile subscribers can access the same wealth of information from a pocket-sized device as they can from the desktop.

WAP is a global standard and is not controlled by any single company. The initial objective of WAP was to define an industry-wide specification for developing applications over wireless communications networks. The WAP specifications define a set of protocols in application, session, transaction, security, and transport layers, which enable operators, manufacturers, and applications providers to meet the challenges in advanced wireless service differentiation and fast/flexible service creation.

One such protocol being developed by the WAP Forum is the WAP User Agent Profile (UAPROF). By utilizing the UAPROF protocol, it is intended that future WAP devices, e.g., communication devices supporting WAP Version 2.0 and beyond, will be able to communicate their capabilities to a network server. UAPROF is a CC/PP application (Composite Capability/Preference Profile) which is a description of device capabilities and user preferences that can be used to guide the adaptation of content presented to a particular device.

As the number and variety of devices connected to the overall communication system, e.g., the Internet, grows, there is a corresponding increase in the need to deliver content that is tailored to the capabilities of different devices. As part of a framework for content adaptation and contextualization, a general-purpose profile format is required that can describe the capabilities of a user agent and preferences of its user. CC/PP is designed to be such a format.

A CC/PP profile contains a number of attribute names and associated values that are used by a server to determine the most appropriate form of a resource to deliver to a client. It is structured to allow a client and/or proxy to describe their capabilities by reference to a standard profile, accessible to an origin server or other sender of resource data, and a smaller set of features that are in addition to or different than the standard profile. A set of CC/PP attribute names, permissible values and associated meanings constitute a CC/PP vocabulary. CC/PP is designed to be broadly compatible with the earlier UAPROF specification from the WAP Forum. That is, any valid UAPROF profile is intended to be a valid CC/PP profile.

WAP UAPROF considers five different categories of device capability: software, hardware, browser, network and WAP. This means the server is intended to be able adapt to the capabilities of the network as well as the capabilities of the device.

WML (Wireless Markup Language), formerly called HDML (Handheld Devices Markup Languages), is a language that allows the text portions of Web pages to be presented on cellular telephones and PDAs via wireless access. WML is part of the WAP that is being proposed by several vendors to standards bodies.

However, existing markup languages and content written in those markup languages presume that devices have similar display sizes, memory capacities, and software capabilities. Content is also largely oblivious to the available network bandwidth and perceived network latency. As WAP-enabled devices come of age, this homogeneity presumption is no longer universally valid. In particular, mobile devices can be expected to have an ever-divergent range of input and output capabilities, network connectivity, and levels of scripting language support. Moreover, users may have content presentation preferences that also cannot be transferred to the server for consideration. As a result of this device heterogeneity and the limited ability of users to convey their content presentation preferences to the server, clients may receive content that they cannot store, that they cannot display, that does not conform to the desires of the user or that takes too long to convey over the network to the client device.

WAP UAPROF is a protocol that is designed to address the device heterogeneity problem. Unfortunately, as mentioned above, UAPROF is only supported on mobile devices running WAP Ver. 2.0 or beyond, and such devices do not yet exist.

### OBJECTS OF THE INVENTION

To address the above-mentioned deficiencies in conventional GSM mobile communication devices, it is an object of the present invention to provide a relatively inexpensive and compact receiving device that enables a sending device to query the receiving device with respect to its capabilities prior to a communication being sent to the receiving device.

It is a further object of the present invention to provide a mobile communication system in which a communication-sending device can format, or modify, a communication to be sent based upon received capabilities of a mobile device to which the communication is to be sent.

### SUMMARY OF THE INVENTION

In accordance with the objectives stated above, a method and a device within a system using the method are disclosed that will enable every GSM device (beginning with second generation (2G) devices that have a SIM card of version 2 or higher) to communicate the device-specific capabilities of the GSM device to the sending device of a communication so the sender can format the communication accordingly to accommodate the capabilities of the receiving device. The invention utilizes a real-time query to the receiving device initiated by a server within the cellular network. Employing a system and device in accordance with the invention saves valuable time and eliminates the dependency on handset manufacturers to include the UAPROF into their handsets, particularly when mobile users want to provide MMS (Multimedia Messaging Service) and UM multimedia services.

A server within a communication network interrogates a GSM device and registers the results, for example, by utilizing SMS communications. Thus, SMS acts as a bearer for user device capabilities interrogation. A utility-type microprocessor is linked to a GSM handset to perform the interrogation of the receiving device and to conduct communication with the server.

### BRIEF DESCRIPTION OF THE DRAWINGS

The above objects and advantages of the present invention will become more apparent by describing in detail certain embodiments thereof with reference to the attached drawings in which:

FIG. 1 is a block diagram showing an embodiment of the handset used in accordance with the present invention.

FIG. 2 is a block diagram showing an embodiment of how a handset can be integrated with a cellular network in accordance with the present invention.

FIG. 3 is a flow chart illustrating a method in accordance with the present invention.

### DETAILED DESCRIPTION OF THE PREFERRED EMBODIMENTS

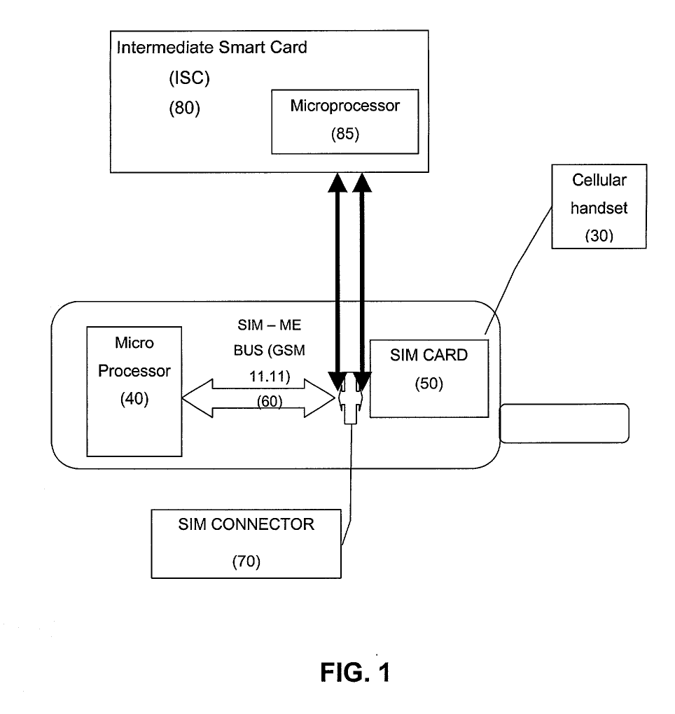

As shown in FIG. 1, a microprocessor (85) within an Intermediate Smart Card (ISC) (80) is linked to the GSM 11.11 standard bus (60) (a signal bus connecting the handset microprocessor (40) and the SIM card (50)). Microprocessor (85) uses the SIM toolkit commands in accordance with the GSM 11.14 standard to communicate with the handset microprocessor (40) and the SIM Card (50). The toolkit commands enable microprocessor (85) to determine many details with respect to the handset (30), e.g., display size and resolution, handset type, operating language, etc. Linking the ISC, or more particularly the microprocessor (85), to the GSM 11.11 bus (60) is detailed in commonly owned co-pending U.S. patent application Ser. No. 09/915,563 by the same inventor, which is incorporated herein by reference for all it teaches.

In addition to linking microprocessor (85) of ISC (80) to the GSM 11.11 bus (60), the present invention includes additional features that permit the handset (30) to provide its device-specific capabilities to a network server, discussed later, to ensure proper formatting for incoming messages, data, etc. As detailed in the commonly owned co-pending application mentioned above, microprocessor (85) can “listen” to SMS messages received by handset (30). SMS retrieval by microprocessor (85) is possible since all SMS messages are capable of being transmitted from the handset's microprocessor (40) to the SIM card (50) using the same bus (60) mentioned earlier the GSM 11.11 bus. The handset can be configured by using a SIM TOOLKIT command to place all received SMS messages on the bus. This SIM TOOLKIT command is sent from the ISC (80) to the microprocessor of the handset. After that in interrogation command can be sent from the ISC (80) to the handset's microprocessor to assure that this status was not changed. The inserted microprocessor (85) reviews all incoming SMS messages and looks for a particular SMS message having a specific code that can activate a “user profile routine” resident within the inserted microprocessor (85).

For example, each short message (SMS) is made up of two basic elements, the header and the user data. The header is a standard for the SMS structure. However, within the user data, according to this embodiment, a proprietary header is defined to distinguish between all applications that the user device will be able to support. The proprietary header identifies each proprietary SMS, i.e., the SMS messages that are not standard SMS messages and that are addressed to the ISC (80). Thus, a message intended to interrogate the receiving device will get a special header defined within the user data of a standard SMS message and once the special header is identified, the user profile routine is activated.

Once the user profile routine is activated, microprocessor (85) queries the handset's microprocessor (40) about the handset (30) type, display size and resolution, operating language, etc. It should be noted that although certain specific device capabilities or characteristics are mentioned herein as examples, skilled artisans would realize that other current characteristics not mentioned herein, or even those not yet developed, would also be within the scope of the present invention.

For example, future characteristics that would be supported include J2ME—Java to Micro Equipment software, a java applet especially tailored for cellular handsets and that enables various applications on handsets. Furthermore, different operating systems, e.g., the EPOC (from Symbian) or Palm operating systems or Microsoft WIN CE, etc. could be supported by the present invention. Additionally, MP3, or other audio formats, would also be supported by the present invention.

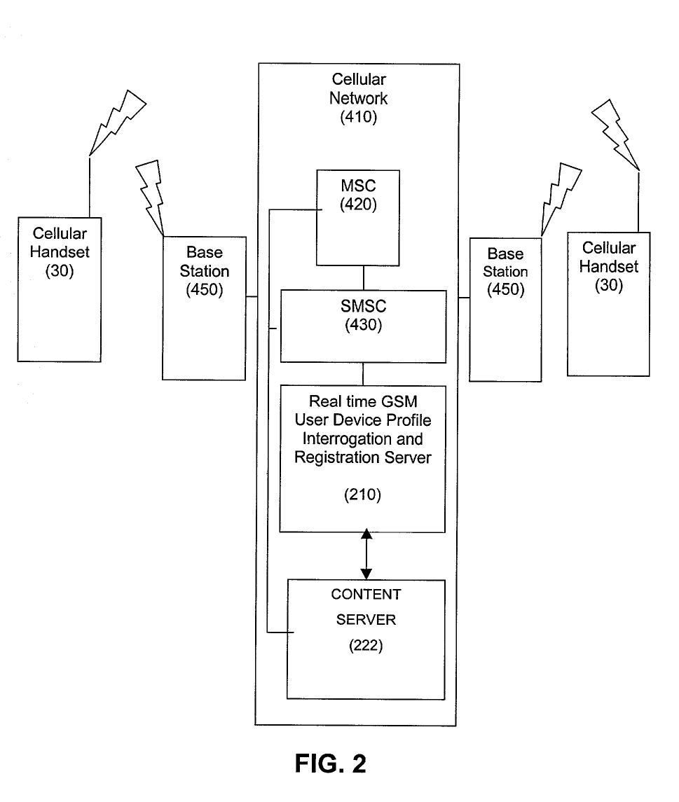

Querying the handset microprocessor (40) by ISC microprocessor (85) is performed in accordance with the SIM Toolkit commands described in the GSM 11.14 standard. In response, microprocessor (40) sends a response to microprocessor (85) through bus (60). Upon receiving a response from microprocessor (40) in regard to the device capabilities, microprocessor (85) initiates a reply, for example a reply SMS, to be sent to a special server (210) (shown in FIG. 2) located within the service provider network (410). Server (210) can be the same server that sent the original SMS message to device (30) or it can be a different server if certain conditions, such as resource allocation, require.

To ensure efficient communication between network (410) and handset (30), server (210) is preferably a real-time user profile registration and interrogation server that provides the service provider within network (410) the information needed regarding the capabilities of each GSM user's handset (30). The inserted microprocessor (85) can be linked to the GSM 11.11 bus (60) by using the standard SIM connector (70), which is the same connector that the SIM card (50) is connected to when SIM card (50) is inserted into the handset (30). In order to permit real-time user device profile interrogation and registration, server (210) should ideally be added to the SMSC (430) within network (410). SMSC (430) is a server that provides the SMS service.

Additionally, since it is possible for applications servers located within a cellular network to designate a short message as ‘high priority’, and, accordingly, modify the order of message delivery, the real time server (210) can designate an interrogation SMS as ‘high priority’ and, thus, the server(s) within SMSC (430) will process the interrogation SMSs before standard SMS messages. Further, the server(s) within SMSC (430) can process high priority, interrogation, SMSs by storing them in a separate queue from normal priority SMSs.

As shown in FIG. 2, a system architecture in accordance with the present invention includes basic elements of a GSM network, e.g., a base station (450) which performs direct radio communication with the handsets (30), MSC (420) which performs the switching function and the SMSC (430) which is the server that provides the SMS services. Additionally, a system in accordance with the present invention includes an interrogating server (210) connected to the SMSC (430). Furthermore, a content server (222), e.g., an MMS (multi media services server) is located within the architecture of the GSM or further technology such as 3G Such a server (222) is connected to the interrogating server (210) and queries the interrogation server (210) about the destination handset's capabilities before sending content to the handset. This interrogation is done to insure that the destination handset will be capable of receiving (e.g., has enough memory) and displaying the content (e.g., has a color display or MP3 playing capabilities).

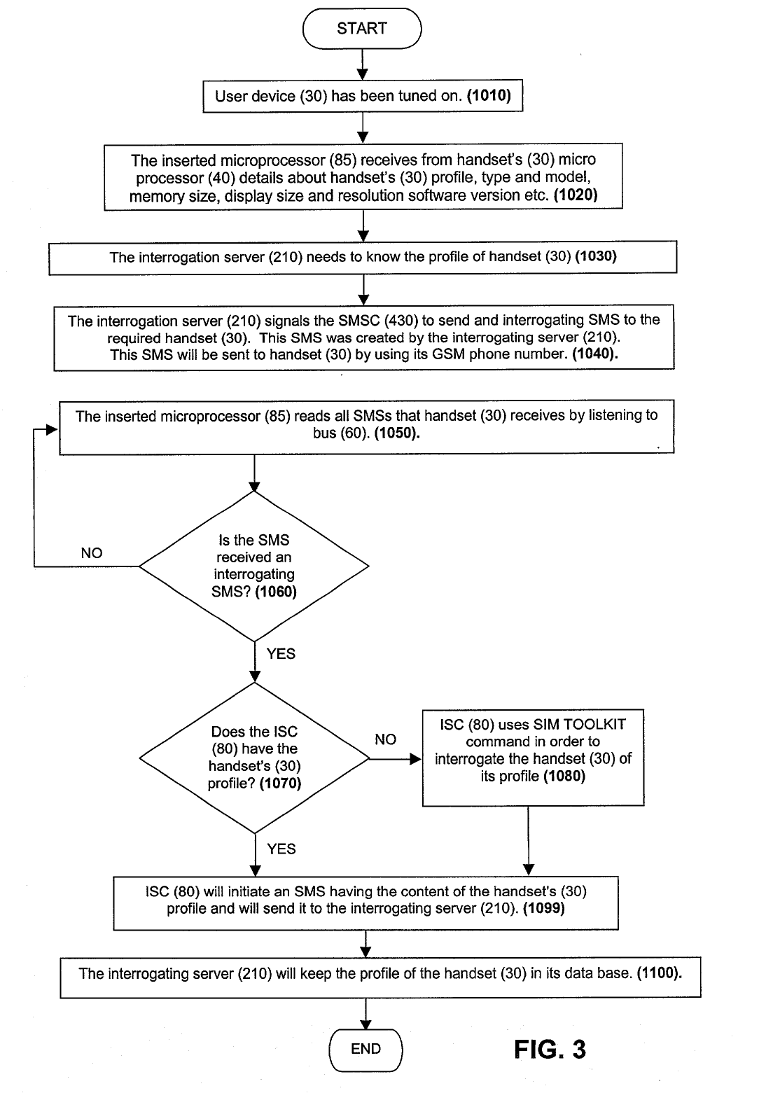

A method in accordance with the present invention will now be discussed in detail. Referring to FIG. 3 for reference numbers corresponding to the method procedures and referring to FIGS. 1 and 2 for reference numbers corresponding to relevant devices, user device, e.g., cellular handset (30), is initially turned ON. (1010). The inserted microprocessor (85) within device (30) receives, from microprocessor (40), details regarding the handset's (30) profile, for example, the type of device and model, memory size, display size, resolution, software version, etc., as mentioned above. (1020). To properly format the message to be sent to handset (30), the interrogation server (210) within the cellular network (410) needs to know the profile of handset (30). (1030).

The interrogation server (210) signals the SMSC (430) to send an interrogating SMS to the required handset (30). Interrogation server (210) acts like an application server and, therefore, the interface between SMSC (430) and the server (210) is defined, for example in regard to SMPP protocol. Application servers can ask the SMSC to send messages. The interrogating SMS sent to handset (30) is created by the interrogating server (210) and is sent to handset (30) via SMSC (430) and MSC (420) by using the corresponding GSM telephone number of handset (30). (1040).

In order for the interrogation SMS to be useful, the SMS server (SMSC) needs to have a ‘partner’ on the mobile handset side—this ‘partner’ is the ISC (80). However, since ISC (80) is a user-specific device which can be removed from a mobile phone, replaced, stolen, purchased, etc., sending an interrogating SMS to a target mobile device before any other message that might require better knowledge of handset's capabilities is preferable. Furthermore, if the handset (30) does not have an ISC (80) installed, the server (210) will not get a reply and, thus, will treat the handset as unknown.

Server (210) might not get a reply from the handset in the event the handset is otherwise actually unavailable, e.g., the handset has an ISC installed, but the handset is in a location that is outside the reachable calling area, etc. The location of the handset is information that can typically be obtained from the Home Location Register (HLR), which is a basic element of a GSM network, or from a Visitors Location Register (VLR), also a basic element of a GSM network. If the handset is unreachable, however, the capabilities of the device are, obviously, irrelevant to the server since no data can be sent anyway.

By monitoring bus (60), the inserted microprocessor (85) within the ISC (80) “listens” to all regular data, including SMS messages, that handset (30) receives. (1050). The relevant issue at this stage is whether any SMS message received by handset (30) is an interrogating SMS message. (1060).

In the event handset (30) receives an SMS message that is not an interrogating SMS message, the ISC (80) ignores that particular SMS message and continues to listen to all other SMS messages received by handset (30). (1050). However, in the event handset (30) does receive an interrogation SMS message, the ISC (80) must determine if it ‘knows’ the appropriate profile for handset (30). (1070). For example, ISC (80) determines whether the profile for the handset device is stored in memory within the ISC (80). If ISC (80) already has stored the profile for handset (30), e.g., from process (1020), an additional interrogation of handset (30) for its profile is not needed.

However, in the event ISC (80) does not have the profile for handset (30), ISC (80) uses SIM Toolkit commands to interrogate handset (30) for its profile. (1080). Subsequent to obtaining the profile for handset (30), ISC (80) requests handset (30) to initiate a special SMS containing the profile for handset (30) and to send the special SMS to the interrogating server (210). Because the interrogating server (210) is located in the service provider's network (410), it is likely that sending the special SMS with the handset's profile to the interrogating server (210) will be free of charge. (1090). Upon receiving the profile for handset (30), the interrogating server (210) stores the profile in its database. (1100).

Once the server (210) ‘knows’ the handset's capabilities, it can format any message data, e.g., video data, graphics, audio, colors, etc., in accordance with the specific capabilities of the handset and, thus, the delivery of messages to user's handsets becomes more efficient and becomes possible, in some cases, where delivery was previously impossible due to incompatible message formatting.

The above description of the preferred embodiments has been given by way of example. From the disclosure given, those skilled in the art will not only understand the present invention and its attendant advantages, but will also find apparent various changes and modifications to the structures and methods disclosed. For example, the interrogation and registration server 210 can provide the device capability information to external application servers, or the external application servers can directly query the handsets for their capabilities. It is sought, therefore, to cover all such changes and modifications as fall within the spirit and scope of the invention, as defined by the appended claims, and equivalents thereof.

What is claimed is:

1. A mobile communication device comprising:
a primary microprocessor;
a security identity module (SIM) operably connected to the primary microprocessor through a signal bus;
a user-specific device including a secondary microprocessor operable to communicate with said primary microprocessor over the signal bus and further operable to monitor bus data sent to said security identity module (SIM),
wherein the user-specific device is operable to query the primary microprocessor for profile data related to the mobile communication device.

2. A mobile communication device in accordance with claim 1, wherein the primary microprocessor is queried by said secondary microprocessor upon receiving an interrogation message.

3. A mobile communication device in accordance with claim 2, wherein the determination by said secondary microprocessor is performed by analyzing the bus data sent to said security identity module (SIM) from said primary microprocessor.

4. A mobile communication device in accordance with claim 2, wherein the interrogation message is generated by a server located in the mobile network.

5. A mobile communication device in accordance with claim 2, wherein the interrogation message is generated by a server located outside the mobile network.

6. A mobile communication device in accordance with claim 1, wherein the device-specific profile data comprises at least one of the display size, the memory capacity, and the software capabilities of the communication device.

7. A mobile communication device in accordance with claim 4, wherein the communication device is operable to transmit a reply message containing the device-specific profile data of the mobile communication device to the server.

8. A communication device in accordance with claim 7, wherein the server stores the device-specific profile data corresponding to the communication device to enable the mobile network to format messages in compliance with the device-specific profile of the communication device.

9. A communication system comprising:
a mobile communication network;
a plurality of mobile communication devices; and
at least one base station operable to transmit messages between said mobile communication network and said plurality of mobile communication devices,
wherein said mobile communication network comprises a user profile server operable to interrogate said mobile communication devices regarding device-specific profile data corresponding to each mobile communication device and store results of the interrogation.

10. A communication system in accordance with claim 9, wherein at least one of said communication devices comprises:
a primary microprocessor;
a security identity module (SIM) operably connected to said primary microprocessor through a signal bus;
a secondary microprocessor operable to communicate with said master microprocessor over the signal bus and further operable to monitor data sent to said security identity module (SIM),
wherein said communication device is operable to provide device-specific profile data to the user profile server upon receiving the interrogation from the user profile server.

11. A communication system in accordance with claim 9, wherein a message sent from the mobile communication network to at least one mobile communication device is specifically formatted for the mobile communication device in accordance with the stored results of the interrogation of the mobile communication device.

12. A communication system in accordance with claim 11, wherein the message sent from the mobile communication network to the mobile communication device comprises at least one of audio data, video data, and text data.

13. A communication system in accordance with claim 9, wherein the interrogation of the mobile communication device by said mobile communication network and a response to the interrogation from the mobile communication device to said mobile communication network is an SMS message.

14. A communication system in accordance with claim 10, wherein the signal bus is in accordance with GSM standard 11.11.

15. A method of transmitting device-specific messages between a mobile communication network and at least one of a plurality of mobile communication devices, the method comprising:
sending an interrogation message to the mobile communication device, the interrogation message soliciting device-specific profile data corresponding to the mobile communication device; and
replying to the interrogation message with device-specific profile data corresponding to the mobile communication device.

16. A method in accordance with claim 15, further comprising:
formatting a primary message that contains data desired to be sent to the mobile communication device, wherein the format of the primary message is in accordance with the device-specific profile data contained in the response; and
transmitting the primary message from the mobile communication network to the mobile communication device.

17. A method in accordance with claim 15, wherein the interrogation message and the response are SMS messages.

18. A method in accordance with claim 15, further comprising:
monitoring regular data being transmitted between a primary microprocessor and a security identity module (SIM) over a signal bus of the mobile communication device; and
determining when the interrogation message has been received by the mobile communication device,
wherein the interrogation message is unique from the regular data and is only used to solicit the device-specific profile data.

19. A method in accordance with claim 15, wherein the device-specific profile data comprises at least one of the display size, the memory capacity, and the software capabilities of the communication device.

20. A user-specific device operable to interface with a mobile communication device, the user-specific device comprising:
an interface portion operable to interface with a signal bus of the mobile communication device;
a microprocessor operable to receive isolated data from said interface portion and process the isolated data, wherein the isolated data is uniquely identifiable from normal data sent to a SIM card of the mobile communication device, identification of the isolated data being performed by said microprocessor by recognizing a unique data header associated with the isolated data.

21. A user-specific device as claimed in claim 20, wherein the signal bus is in accordance with GSM standard 11.11.

22. A user-specific device as claimed in claim 20, wherein the isolated data is a request for device specific capabilities of the mobile communication device.

23. A user-specific device as claimed in claim 20, wherein the user-specific device communicates with a primary microprocessor of the mobile communication device in accordance with GSM standard 11.14.
